(19) United States
(12) Patent Application Publication
(10) Pub. No.: US 2006/0249553 A1
(43) Pub. Date: Nov. 9, 2006

(54) Ultrasonic induced crack propagation in a brittle material

(76) Inventor: Ljerka Ukrainczyk, Painted Post, NY (US)

Correspondence Address: CORNING INCORPORATED, SP-TI-3-1, CORNING, NY, 14831, US

(21) Appl. No.: 11/124,435

(22) Filed: May 6, 2005

(51) Int. Cl. B26F 3/00

(52) U.S. Cl. 225/2; 225/94; 83/880

(57) ABSTRACT

A sheet of brittle material is separated along a score line by applying ultrasonic energy to previously scored sheet material. The brittle material can be in the form of a moving ribbon, wherein a load is applied transverse to the score line to enhance crack propagation along the score line.

### BACKGROUND OF THE INVENTION

1. Field of the Invention

The present application relates to the separation of a sheet of brittle material, and more particularly, to crack initiation and propagation along a score line in response to the application of ultrasonic energy to the brittle material.

2. Description of Related Art

Two techniques are conventionally employed for cutting or shaping a sheet of brittle material, such as a glass, amorphous glass, glass-ceramic or ceramic material, to form a piece with a desired configuration or geometry.

A first conventional method involves mechanical scribing of the sheet by a hard device such as a diamond or tungsten tip to score the surface of the brittle material, which is then broken along the score line in response to a bending moment applied to the material. Typically, the bending moment is applied by physically bending the brittle material about the score line. However, this process induces significant energy to the sheet by virtue of the bending moment, and is thus unsuitable for certain configurations or manufacturing processes of the material. This method of separation also often introduces twist-hackle along the newly formed edges.

The second conventional technique involves laser scribing, such as described in U.S. Pat. No. 5,776,220. Typical laser scribing includes heating a localized zone of the brittle material with a continuous wave laser, and then immediately quenching the heated zone by applying the coolant, such as a gas, or a liquid such as water. The separation of laser scribed material can be achieved either by mechanical breaking using bending as with the mechanical scribing, or by second higher energy laser beam. The use of second higher energy laser beam allows for separation without bending. However, the separation is slow and often is difficult to control crack propagation. The second laser beam also creates thermal checks and introduces high residual stress.

Therefore, the need exists for the repeatable and uniform separation that does not require bending of a sheet of brittle material, while minimizing manipulation of the sheet. The need also exists for a reduced disturbance separation that can be used during vertical forming (on the draw) or during horizontal forming (e.g. float glass). The need also exists for reducing the twist-hackle distortion commonly associated with bend induced separation. The need exists for the separation of a brittle material along a score line, without requiring physical bending of the material, or the introduction of extreme temperature gradients. There is a particular need for the separation of a pane from a continuously moving ribbon of brittle material, while reducing imparted disturbances which can propagate upstream along the ribbon.

### BRIEF SUMMARY OF THE INVENTION

The present invention provides for the separation of a brittle material without requiring application of a significant bending moment, or an impact loading. The present system also provides for the repeatable and uniform separation of a pane of brittle material from a continuously moving ribbon of the brittle material, while reducing the introduction of disturbances into the ribbon. The present system further allows for a separation of a sheet of brittle material which reduces twist-hackle commonly observed in bending moment induced separation.

The present system can be used for separating a stationary, independent or fixed sheet of material. However, particular applicability has been found for separating a pane from a ribbon of material, and further applicability has been found for separating a pane of glass from a moving ribbon of glass.

Generally, ultrasonic energy is applied to the brittle material to form a crack and propagate the crack along a previously formed score line. Typically, the ultrasonic energy is applied in the local region of the score line, either at the score line, or the opposed side of the material.

In a further configuration, separation of the brittle material along the score line is enhanced by application of a transverse load to the score line prior to application of the ultrasonic energy. By applying a load, the sheet is tensioned and can efficiently propagate the ultrasonic energy applied at one localized point. By selecting the frequency of the ultrasonic energy, the amplitude of the ultrasonic energy and the tension across the score line, the present system can be used to separate a number of brittle materials.

In a current configuration for separating a pane of glass from a continuous ribbon of the glass, the present invention reduces the introduction of detrimental disturbances that can migrate upstream in the ribbon. The present invention allows for the separation of a pane from the ribbon without imparting a substantive bending moment or impact loading associated with prior systems. Thus, reduced energy migrates upstream in the ribbon.

Additional features and advantages of the invention are set forth in the detailed description which follows, and in part will be readily apparent to those skilled in the art from that description or recognized by practicing the invention as described herein. For purposes of description, the following discussion is set forth in terms of glass manufacturing. However, it is understood the invention as defined and set forth in the appended claims is not so limited, except for those claims which specify the brittle material is glass.

It is to be understood that both the foregoing general description and the following detailed description are merely exemplary of the invention, and are intended to provide an overview or framework for understanding the nature and character of the invention as claimed below. Also, the above listed aspects of the invention, as well as the preferred and other embodiments of the invention discussed and claimed below, can be used separately or in any and all combinations.

The accompanying drawings are included to provide a further understanding of the invention, and are incorporated in and constitute a part of this specification. The drawings illustrate various embodiments of the invention, and together with the description serve to explain the principles and operation of the invention. It should be noted that the various features illustrated in the figures are not necessarily drawn to scale. In fact, the dimensions may be arbitrarily increased or decreased for clarity of discussion.

### BRIEF DESCRIPTION OF THE SEVERAL VIEWS OF THE DRAWING(S)

FIG. 1 is a perspective schematic showing an apparatus for forming a ribbon of brittle material.

FIG. 2 front elevational schematic view of the ribbon extending from a fusion glass fabrication apparatus.

FIG. 3 is a side elevational schematic of the ultrasonic energy applied to the ribbon.

FIG. 4 is a side elevational view of a horizontal sheet of brittle material for separation by the application of ultrasonic energy.

FIG. 5 is a side elevational view of a sheet of brittle material for separation by the application of ultrasonic energy in conjunction with an applied load transverse to the score line.

### DETAILED DESCRIPTION OF THE INVENTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention can be practiced in other embodiments that depart from the specific details disclosed herein. Moreover, descriptions of well-known devices, methods and materials may be omitted so as not to obscure the description of the present invention.

The present invention provides for the ultrasonic induced separation of a brittle material without requiring a bending or impacting of the brittle material. In one configuration, the present invention provides for the separation of a pane of a brittle material from a moving ribbon of the material, wherein selected configurations reduce the introduction of disturbances which can propagate upstream in the ribbon. For purposes of description, the present invention is initially set forth as separating a glass pane from a moving ribbon of glass.

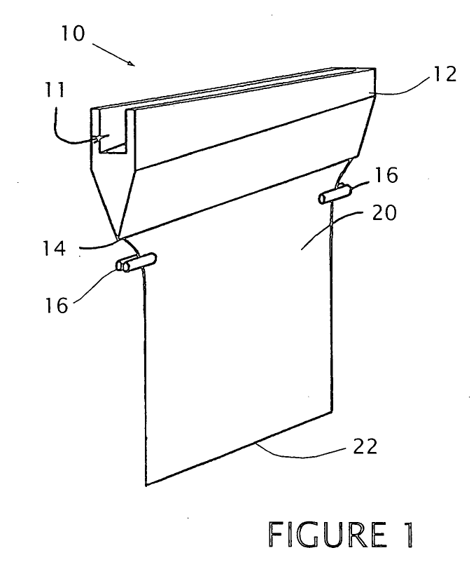

FIG. 1 is a schematic diagram of glass fabrication apparatus 10 of the type typically used in the fusion process. The apparatus 10 includes a forming isopipe 12, which receives molten glass (not shown) in a cavity 11. The molten glass flows over the upper edges of the cavity 11 and descends along the outer sides of the isopipe 12 to a root 14 to form the ribbon of glass 20. The ribbon of glass 20, after leaving the root 14, traverses fixed edge rollers 16. The ribbon 20 of brittle material is thus formed and has a length extending from the root 14 to a terminal free end 22.

Such draw down sheet or fusion processes, are described in U.S. Pat. No. 3,338,696 (Dockerty) and U.S. Pat. No. 3,682,609 (Dockerty), herein incorporated by reference. Thus, details are omitted so as to not obscure the description of the example embodiments. It is noted, however, that other types of glass fabrication apparatus can be used in conjunction with the invention. For those skilled in the art of glass forming, it is known that there are multiple methods to achieve such a structure, such as laminated down draw, slot draw and laminated fusion processes.

In the fusion, or other type of glass manufacturing apparatus, as the glass ribbon 20 travels down from the isopipe 12, the ribbon changes from a supple, for example 50 millimeter thick liquid form at the root 14 to a stiff glass ribbon of approximately 0.03 mm to 2.0 mm thickness, for example, at the terminal end 22.

In the formation process of the ribbon 20, the ribbon transforms from a liquid state at the root 14 to a down the stream solid state at the terminal end 22 of the ribbon. The introduction of disturbances into the transforming glass can result in undesired nonuniformity in the resulting glass in the solid state. Traditionally, the separation of a pane from the ribbon, introduced significant energy in the form of a wave or distortion to the solid portion of the ribbon. Such distortion would migrate upstream into the transition from the molten portion of the ribbon to the solid portion. As the distortion dissipates in the transformation portion of the ribbon, nonuniformity and nonlinearity are introduced in an uncontrolled manner, and can decrease the uniformity of subsequent panes.

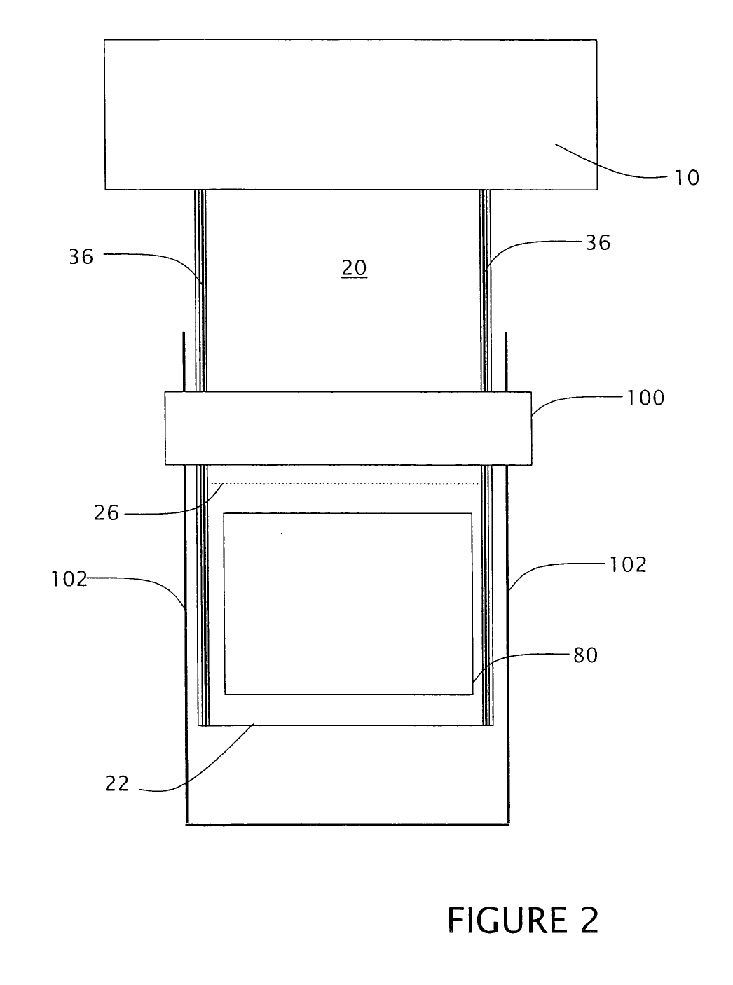

For purposes of definition, as the ribbon 20 descends from the root 14, the ribbon travels at a velocity vector describing movement of the ribbon and forms a generally flat member having a generally planar first side 32 (often referred to as the A side) and a generally planar second side 34 (often referred to as the B side). In certain configurations, as seen in FIG. 2, the ribbon 20 includes lateral beads or bulbous portions 36 which are sized for engagement by the fixed rollers 16 or control surfaces during travel of the ribbon from the isopipe 12. With respect to the ribbon 20, the terms “opposed” or “opposing” mean the contact on both the first side and the second side of the ribbon.

The term “upstream” means from the point of interest on the ribbon 20 to the root 14. The term “downstream” means from the point of interest to the terminal end 22 of the ribbon 20.

The separation of a pane 24 from the ribbon 20 occurs within a given distance range from the root 14, along a score line 26 formed in at least one side of the ribbon. That is, under constant operating parameters, the glass ribbon 20 reaches a generally predetermined solid state at a generally constant distance from the root 14, and is thus amenable to separation.

The present system includes a scribing assembly 40, an ultrasonic applicator 60 and a loading assembly 80.

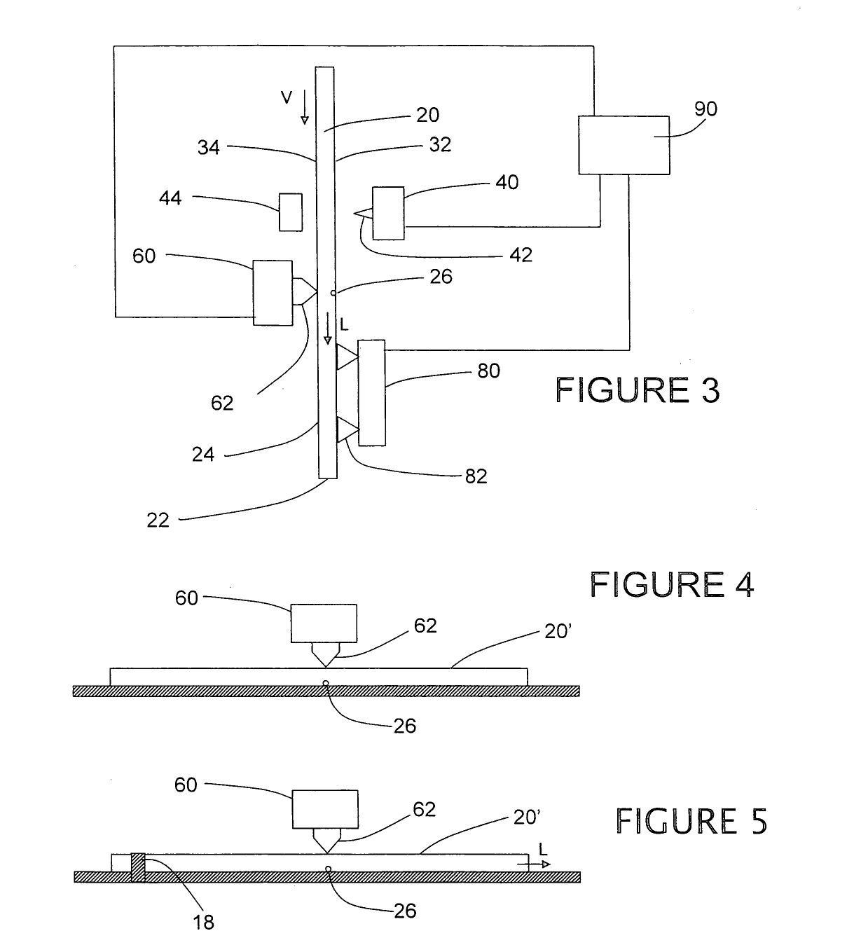

The scribing assembly 40 is used to form a score line 26 on the first side 32 of the ribbon 20. The scribing assembly 40 includes a scribe 42 and in certain configurations, a scoring anvil 44. For purposes of description, the scribe 42 and the scoring anvil 44 are described in terms of travel on a common carriage 100 shown in FIG. 2, and omitted from FIG. 3 for clarity. The carriage 100 can be movable relative to a frame 102, wherein the movement of the carriage can be imparted by any of a variety of mechanisms including mechanical or electromechanical, such as motors, gears rack and pinion, to match the velocity vector of the ribbon 20.

Thus, the scribe 42 will travel along the direction of travel of the ribbon 20, at a velocity vector matching the ribbon. As the scribe 42 translates along the same direction of travel as the ribbon 20, the score line 26 can be formed to extend transverse to the direction of travel of the ribbon.

The scribe 42 can be any of a variety of configurations well known in the art, including but not limited to lasers, wheels, points or tips, including diamond, carbide, zirconium or tungsten.

For those configurations of the scribe 42 that require contact with the ribbon 20 to form the score line 26, the scribe is also movable between a retracted non contacting position and an extended ribbon contacting position.

For contacting scribes, the scribe 42 cooperates with the scoring anvil 44 to form the score line 26 along the first surface 32 of the ribbon 20.

Typically, the score line has a depth of approximately 10% of the thickness of the sheet material, the ribbon 20. Thus, for the ribbon 20 having a thickness of approximately 0.7 mm to 1.3 mm, score line 26 can have a depth ranging from approximately 70 microns to 130 microns. For glass panes used in display systems, or substrates, the ribbon usually has a thickness between 0.4 mm and 3.0 mm, thus the score line 26 can have a depth ranging from approximately 40 microns to 300 microns. However, it is understood that different materials, operating temperatures and ultrasonic applicators 60 can require an adjustment of the depth of the score line 26 with respect to the thickness of the ribbon 20.

In the separation of the pane 24 from the ribbon 20, the score line 26 is linear and extends across the ribbon between the beads 36. Thus, score line 26 has a longitudinal dimension extending along a length of the score line.

The ultrasonic applicator 60 couples ultrasonic energy to the ribbon 20. The ultrasonic applicator is a commercially available product such as USW 335 Minicutter, as marketed by Honda Electronics or Ultrasonic Processor Model VC-2515 and Model VC-505, as marked by Sonics & Materials, Inc. A variety of mechanisms can be used to generate the ultrasonic energy. For example, an oscillator crystal or a magnetostrictive modulator, such as a nickel rod in a strong magnetic alternating field can be used. The ultrasonic applicator 60 includes a coupler 62 for introducing the ultrasonic energy to the ribbon 20. The coupler 62 can have any of a variety of configurations such as a knife or blade, an edge, or a point. A satisfactory coupler 62 has been found to be a blade having a length of approximately 6 mm. A satisfactory power rating for the ultrasonic applicator 60 has been found to be approximately 30W. However, depending upon the specific material of the ribbon 20, the depth of the score line 26, and the amount transverse loading, the ultrasonic applicator 60 can have a power rating from approximately 10W to approximately 300W.

Typically, the ultrasonic energy is in the form of an ultrasonic vibration. The frequency of the ultrasonic vibration is between approximately 15 kHz and approximately 400 kHz. However, it is understood that higher frequencies, greater than 400 kHz, such as approximately 700 kHz to approximately 1.2 MHz can be employed, and are intended to be encompassed by the term ultrasonic. In some literature, it is noted that frequencies between approximately 700 kHz and 1.2 MHz are described as megasonic frequencies. It is understood such frequencies are encompassed by the term ultrasonic. It is advantageous to use ultrasonic frequencies, as such frequencies are outside of hearing range and due to the high frequencies and relatively low amplitude, as described below, do not cause sufficiently high amplitude vibrations of the ribbon 20 to produce undesirable distortions in the ribbon. However, it is also understood frequencies lower than 15 kHz which are outside the ultrasonic range can be used. The amplitude of the vibration is typically in range from approximately 20 micrometers to approximately 100 micrometers, with a satisfactory range of approximately 40 micrometers to approximately 80 micrometers. However, it is understood the specific amplitude of the vibration is in part determined by the composition and size of the brittle material, as well as the configuration of the coupler 62.

The loading assembly 80 shown in FIGS. 2 and 3 is employed to apply a load or force L on the ribbon 20 transverse to the longitudinal dimension of the score line. That is, the loading is along the direction of travel of the ribbon 20. In the configuration for separating a pane 24 from the ribbon 20, the loading is along the velocity vector V. However, it is contemplated that the transverse loading (or tension) can be a component of a load or force vector applied to the ribbon 20.

In one configuration, the loading assembly 80 also engages the ribbon 20 downstream of the score line 26 and controls removal of the pane 24 upon separation from the ribbon 20. A representative loading and pane engaging assembly 80 and associated transporter are described in U.S. Pat. No. 6,616,025, herein expressly incorporated by reference.

The loading assembly 80 includes pane engaging members 82, such as soft vacuum suction cups. It is understood other devices for engaging the pane 24, such as clamps can be used. The number of pane engaging members 82 can be varied in response to the size, thickness and weight of the pane 24.

The loading assembly 80 can employ any of a variety of mechanisms for applying the loading across the score line 26. For example, pneumatic or hydraulic pistons or cylinders can be connected to the pane engaging members to apply a force parallel to or coextensive with the velocity vector of the ribbon 20. Preferably, the loading assembly 80 can apply a controllable and adjustable transverse force across the score line 26. Typical loading values can range from approximately 2 pounds to 50 pounds, depending upon the length of the score line 26 and the material being separated. Generally, it is advantageous to apply a sufficient tension, such as by the loading assembly, to enhance efficiency of crack propagation.

It is understood the loading assembly 80 can engage the ribbon 20 either before or after the score line 26 is formed.

A controller 90 can be operably connected, by hard wire or wireless, to at least one of the scribing assembly 40, the ultrasonic applicator 60 and the loading assembly 80 to coordinate operation of the components. The controller 90 can be a processor embedded in one of the components. Alternatively, the controller 90 can be a dedicated processor or a computer programmed to allow cooperative control of the scribing assembly 40, the ultrasonic applicator 60 and the loading assembly 80 to provide for separation of the pane 24 from the ribbon 20. That is, the controller 90 can allow for sequencing of the formation of the score line 26, application of the tension transverse to the score line and application of the ultrasonic energy.

In operation, the scribing assembly 40 forms the score line 26 across the first side 32 of the ribbon 30. Subsequently, the coupler 62 is brought into proximity, or contact with the second side 34 of the ribbon 20 and imparts the ultrasonic energy, typically in the form of an ultrasonic vibration to the ribbon 20. By contacting the ribbon 20, the coupler 62 provides a relatively high efficiency of energy transfer to the ribbon. The coupler can contact the second side 34 of the ribbon 20, opposite the score line 26, slightly upstream of the score line or slightly downstream of the score line. Typically, the contact with the coupler 62 is within approximately 1-20 millimeters downstream of the score line 26. The coupler 62 is applied to the unscored side of the sheet. The exact position at which the coupler 62 is contacted with the ribbon 20 depends in part on the geometry of the coupler. Typically, the coupler 62 is 0.1-20 milimeters wide. In the case of a narrow coupler 62, e.g. 0.1 mm, the coupler should touch the unscored side of the ribbon 20 with approximately 0.1 mm of the score line 26. With larger couplers, it is advantageous for the center of the coupler 62 to touch the back of the score line 26. It is contemplated the coupler 62 can contact the ribbon 20 within approximately 1 mm of the vertical position of the score line 26. That is, for a descending ribbon 20, if the score line 26 extends horizontally at a given elevation, the coupler 62 contacts the unscored side of the ribbon 20 within approximately 1 mm of the given elevation. It is contemplated that as the size of the coupler 62 decreases, the distance between the score line 26 and the contact with the coupler should decrease.

The ultrasonic energy initiates a crack along the score line 26 and subsequent crack propagation along the score line. Depending upon the amplitude of the ultrasonic vibration, the depth of the score line 26, the amount of tension applied transverse to the score line and the composition of the ribbon 20, the crack propagation can extend along the score line from approximately five times the depth of the score line to 15 to 20 inches or the entire length of the score line. In selected configurations, the crack can propagate beyond the length of the score line 26.

It is also understood the coupler 62 can be contacted with the ribbon 20 the on the scored side, the first side 32, of the ribbon. The vertical spacing of the coupler 62 contact and the ribbon 20, with respect to the position of the score line 26, are as previously set forth. While such location for coupling the ultrasonic energy to the ribbon 20 provides for crack initiation and propagation along the score line 26, potentially undesirable debris generation occurs. Thus, to reduce debris generation, the coupler 62 is advantageously contacted with the unscored side of the ribbon 20.

It is further contemplated that a single or a plurality of couplers 62 can be simultaneously, or sequentially contacted with the ribbon 20 to induce crack propagation along a local section of the score line 26. However, as the cracks resulting from multiple initiation points can extend along slightly different planes of the brittle material, it is believed advantageous to apply sufficient loading transverse to the score line 26 in conjunction with sufficient ultrasonic energy to provide for crack propagation along the entire length the score line from a single initiation point. In addition, it is advantageous that the ultrasonic energy is continuously applied during the crack propagation.

Referring to FIG. 4, a scored sheet 20′ of glass is disposed on a horizontal surface and the ultrasonic application introduces ultrasonic energy to the unscored side of the sheet 20′. In FIG. 5, the sheet 20′ is clamped with respect to the substrate by clamp 18 and a load L is applied transverse to the length of the score line 26.

In theory it is believed that ultrasonic applicator 60 transfers low amplitude vibration to the ribbon 20. If the ribbon 20 is tensioned, the vibration propagates efficiently and induces the crack where a defect is present in the glass, such as the score line 26.

With reference to specific examples, to further illustrate the invention, without limiting the invention, is a first example, a score line 26 having a 70 micron depth was formed in a glass sheet having thickness of 0.7 mm. Thus, the score line had a depth of 10% of the substrate thickness. The sheet was supported on a horizontal surface, with the scored side of the sheet contacting the horizontal surface as seen in FIG. 4. An ultrasonic applicator 60, with a blade coupler 62 having a length of approximately 6 mm and operating at 20 kHz was placed in contact with the sheet generally opposite the score line 26. Resulting crack propagation distances were approximately 5 to approximately 6 cm. For a score line 26 have any depth of approximately 5% of the sheet thickness, and the application of the same 20 kHz vibration with a 6 mm long coupler, resulted in no crack initiation and hence no crack propagation. Thus, there appears to be a threshold depth of the score line 26 to allow for crack propagation in response to the application of ultrasonic energy at 20 kHz, when there is no tension applied to the ribbon.

In a second example, the score line 26 was formed in a rectangular glass sheet of approximately 1.3 meters by 1.1 meter, with a thickness of 0.7 mm. The score line had a depth of 70 micrometers (10% of the sheet thickness) and extended across the width of the sheet. The scored sheet was vertically oriented with the score line 26 extending horizontally, and a 6 pound load was attached to the sheet below the score line. The same ultrasonic applicator 60, as used in the first example, operating at 20 kHz, was used with the coupler 62 contacting the unscored side of the sheet. A crack initiated and propagated along the entire length of the score line 26 from a single initiation point, with no observable twist-hackle.

In a third example, the score line 26 was formed in a rectangular glass sheet of approximately 1.3 meters by 1.1 meter, with a thickness of 0.7 mm. The score line had a depth of 70 micrometers (10% of the sheet thickness) and extended across the width of the sheet. The scored sheet was vertically oriented with the score line extending horizontally. No external tension loading was applied transverse to the score line 26. That is, no tensioning was applied to the sheet. The weight of the sheet was the same as the sheet in the second example. Only the weight of the sheet was exerted transverse to the score line 26. The same ultrasonic applicator 60, as used in example 2, operating at 20 kHz with the coupler 62 was contacted with the unscored side of the sheet. A crack initiated and propagated along the score line 26 for approximately 0.7 meters then arrested. Thus, it is conjectured that transverse loading across the score line 26 must be applied, or a higher ultrasonic vibration applied to provide for crack propagation along the entire length of the score line.

While the invention has been described in conjunction with specific exemplary embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A method of separating a sheet of brittle material, the method comprising:
(a) applying sufficient ultrasonic energy to the sheet having a score line to induce a crack and propagate the crack along the score line.

2. The method of claim 1, further comprising employing an ultrasonic vibration as the ultrasonic energy.

3. The method of claim 1, further comprising applying sufficient ultrasonic energy to propagate the crack at least five times a depth of the score line.

4. The method of claim 1, further comprising applying the ultrasonic energy to a scored side of the sheet.

5. The method of claim 1, further comprising applying the ultrasonic energy directly to the score line.

6. The method of claim 1, further comprising applying the ultrasonic energy to an unscored surface of the sheet.

7. The method of claim 1, further comprising applying a tension to the sheet transverse to a length of the score line.

8. The method of claim 1, further comprising applying ultrasonic energy having a frequency greater than approximately 20 kHz.

9. The method of claim 1, wherein applying sufficient ultrasonic energy includes contacting the sheet with a vibrating member.

10. The method of claim 1, further comprising forming the score line to be at least five times a score line depth.

11. The method of claim 1, further comprising forming the sheet as a moving ribbon.

12. A method of separating a sheet of brittle material, the method comprising:
(a) forming a score line in the sheet;
(b) applying a tension to the sheet transverse to a length of the score line; and
(c) applying ultrasonic energy to the sheet to initiate and propagate a crack along the score line.

13. The method of claim 12, further comprising forming the score line to have a depth approximately 10% of the sheet material thickness.

14. The method of claim 12, further comprising applying the ultrasonic energy in the form of an ultrasonic vibration.

15. An apparatus for separating a sheet material, comprising:
(a) a scribing assembly forming a score line in the sheet material;
(b) an ultrasonic applicator coupling ultrasonic energy to the sheet to induce crack initiation and propagation along the score line; and
(c) a controller connected to the scribing assembly and the ultrasonic applicator, the controller selected to couple the ultrasonic energy to the sheet after formation of the score line.

16. The apparatus of claim 15, further comprising a loading assembly for applying a force transverse to a length of the score line.

17. The apparatus of claim 15, wherein the ultrasonic applicator includes a coupler in the form of a blade.

18. The apparatus of claim 15, wherein the ultrasonic applicator includes a coupler in the form of an edge.

19. The apparatus of claim 15, wherein the ultrasonic applicator includes a coupler in the form of a point.

20. The apparatus of claim 15, wherein the ultrasonic applicator imparts an ultrasonic vibration to the brittle material.
